(19) United States
(12) Patent Application Publication
(10) Pub. No.: US 2025/0069357 A1
(43) Pub. Date: Feb. 27, 2025

(54) COMPUTER-READABLE RECORDING MEDIUM STORING INFORMATION PROCESSING PROGRAM, INFORMATION PROCESSING METHOD, AND INFORMATION PROCESSING APPARATUS

(71) Applicant: FUJITSU LIMITED, Kawasaki-shi (JP)

(72) Inventors: Atsunori MOTEKI, Inagi (JP); Junya FUJIMOTO, Atsugi (JP); Yuichi MURASE, Yokohama (JP)

(73) Assignee: FUJITSU LIMITED, Kawasaki-shi (JP)

(21) Appl. No.: 18/942,868

(22) Filed: Nov. 11, 2024

Related U.S. Application Data
(63) Continuation of application No. PCT/JP2022/021770, filed on May 27, 2022.

(51) Int. Cl. G06V 10/25; G06T 7/246

(52) U.S. Cl. CPC G06V 10/25; G06T 7/246; G06T 2207/20044; G06T 2207/30241

(57) ABSTRACT

A non-transitory computer-readable recording medium storing a program for causing a computer to execute a process includes generating three-dimensional first skeleton information of a first person included in a first video by performing skeleton recognition, setting a first interesting region in a three-dimensional space for each of objects included in the first video based on design data, specifying a first object being used by the first person from among the objects included in the first video by using positional information of a hand of the first skeleton information and the first region of interest, acquiring a position distribution in which the hand is present in the three-dimensional space based on a trajectory of the part of the hand of the first skeleton information, and setting a second region of interest, in the three-dimensional space, that indicates that a person uses the first object, based on the position distribution.

### CROSS-REFERENCE TO RELATED APPLICATION

This application is a continuation application of International Application PCT/JP2022/021770 filed on May 27, 2022 and designated the U.S., the entire contents of which are incorporated herein by reference.

### FIELD

The embodiments discussed herein are related to a computer-readable recording medium storing an information processing program, an information processing method, and an information processing apparatus.

### BACKGROUND

When a three-dimensional structure such as a steel tower or a bridge is constructed in a steel construction industry, a member machining process, a welding process, a temporary assembly process, and the like may be performed between design by computer aided design (CAD) and field assembly. In this case, after the temporary assembly process, a member is shipped to a field and the field assembly is performed. A steel member or the like of the three-dimensional structure is machined in the member machining process, temporary welding of a steel member, diagnosis of the temporary welding, and main welding are performed in the welding process, and temporary assembly, disassembly, painting finish, and diagnosis are performed in the temporary assembly process.

Since such a three-dimensional structure is often a large single object, the diagnosis in the welding process and the temporary assembly process is often performed by visual confirmation in which a target object subjected to the temporary welding or painting is compared with a three-dimensional CAD model created at the time of design.

In a case where a failure in the welding process is overlooked at the time of diagnosis and is found during a temporary assembly work, a rework from the temporary assembly process to the member machining process or the like occurs. In a case where a failure in the temporary assembly process is overlooked at the time of diagnosis and is found during a work of the field assembly, a rework from the field assembly to the member machining process or the like occurs.

Thus, in order to suppress the occurrence of the reworks in the temporary assembly and the field assembly, a certain work time is spent for the visual confirmation for comparing the target object with the three-dimensional CAD model. At this time, as the number of members increases, the number of diagnosis locations of the three-dimensional structure also increases, and thus, the work time for the visual confirmation increases. It is not easy to cultivate a skilled worker who may perform diagnosis with high accuracy in a short time, and a cultivation period of the skilled worker may reach several years. Such a problem occurs not only in diagnosis in a construction work of the steel tower, the bridge, or the like but also in a confirmation work of comparing another three-dimensional structure with a model represented by model information thereof.

Accordingly, in order to improve the efficiency of the conformation work of comparing the three-dimensional structure with the model represented by the model information, for example, there is a technique in which edges of a target object in a captured image and a plurality of three-dimensional (3D) line segments included in CAD of the target object are associated with each other and the CAD is displayed to be superimposed on the captured image. Since a position and a pose of the target object are obtained when the CAD is superimposed on the captured image, 3D rectangle information that surrounds the target object may be extracted by using this information, and may be used as a region of interest (ROI) referred to as a target region, a region of concern, a region of interest, or the like.

As described above, for example, when the ROI for the target object may be extracted from a video, for example, a captured image, obtained by a camera installed in a factory, it is possible to analyze a work of a worker on the target object. For example, measures such as optimum arrangement of a person or an object and optimization of a work instruction document may be realized by extracting an ROI of a person or a target object on which the person works from the captured image and measuring a work content, a work location, and a time taken for the work.

FIG. 1 is a diagram illustrating an example of a work recognition technique according to the related art. As illustrated in FIG. 1, in the related art, an information processing apparatus estimates skeleton information 5 of a person from an input image by using an image of a surveillance camera installed in a factory as the input image. The person manually sets an ROI 6 of a target object to be worked by the person, and the information processing apparatus estimates a work content by using a positional relationship between the ROI 6 and the estimated skeleton information 5 of the person. For example, as illustrated in FIG. 1, in a case where a skeleton of a hand of the person is included in the ROI 6, the information processing apparatus determines that the person touches the target object and is performing the work on the target object.

Japanese Laid-open Patent Publication Nos. 2017-091078, 2019-139570, and 2021-177399 and U.S. Patent Application Publication Nos. 2020/0082544 and 2017/0084044 are disclosed as related arts.

### SUMMARY

According to an aspect of the embodiments, a non-transitory computer-readable recording medium storing an information processing program for causing a computer to execute a process includes generating three-dimensional first skeleton information of a first person included in a first video by performing skeleton recognition on the first person, setting a first region of interest in a three-dimensional space for each of a plurality of objects included in the first video, based on design data that is stored in advance and defines regions of the objects present in the three-dimensional space, specifying a first object being used by the first person from among the plurality of objects included in the first video by using positional information of a part of a hand of the first skeleton information and the first region of interest, acquiring a position distribution in which the part of the hand is present in the three-dimensional space based on a trajectory of movement of the part of the hand of the first skeleton information, and setting a second region of interest, in the three-dimensional space, that indicates that a person uses the first object, based on the position distribution in which the part of the hand is present

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a work recognition technique according to the related art;

FIG. 2 is a diagram illustrating an example of ROI acquisition for a target object in a captured image according to the related art;

FIG. 3 is a diagram illustrating a configuration example of an information processing system according to a first embodiment;

FIG. 4 is a diagram illustrating a configuration example of an information processing apparatus according to the first embodiment;

FIG. 5 is a flowchart illustrating a flow of 3D ROI setting processing according to the first embodiment;

FIG. 6 is a diagram illustrating an example of initial image acquisition;

FIG. 7 is a diagram illustrating an example of 3D position and pose estimation of a device;

FIG. 8 is a diagram illustrating an example of conversion of coordinates of the device;

FIG. 9 is a diagram illustrating an example of extraction of a three-dimensional rectangle of a component in the device;

FIG. 10 is a diagram illustrating an example of skeleton information;

FIG. 11 is a diagram illustrating an example of pose determination of a whole body;

FIG. 12 is a diagram illustrating an example of relative 3D skeleton coordinate estimation;

FIG. 13 is a diagram illustrating an example of a positional relationship between coordinate systems in 2D and 3D;

FIG. 14 is a diagram illustrating an example of a work process table;

FIG. 15 is a diagram illustrating an example of 3D ROI setting;

FIG. 16 is a flowchart illustrating a flow of motion determination processing by a 3D ROI according to a second embodiment;

FIG. 17 is a diagram illustrating an example of the motion determination by the 3D ROI; and

FIG. 18 is a diagram for describing a hardware configuration example of the information processing apparatus.

### DESCRIPTION OF EMBODIMENTS

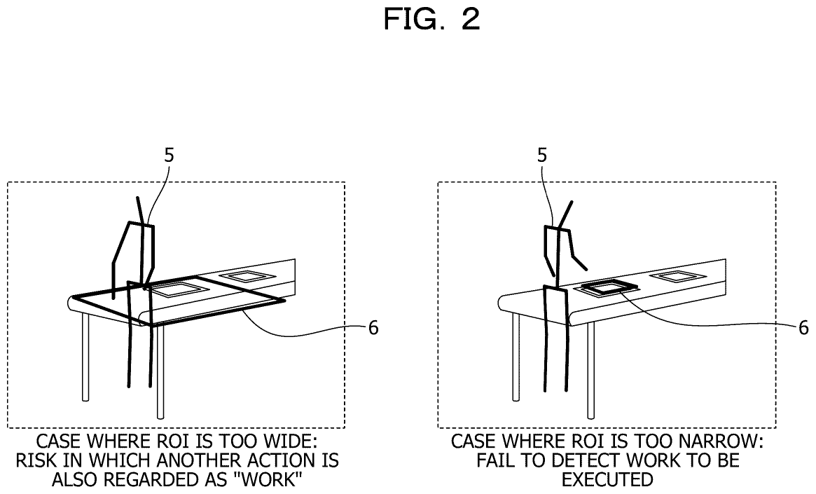

For example, in a case where the ROI is acquired at a component level for the target object in the captured image, sufficient information may not be acquired. FIG. 2 is a diagram illustrating an example of ROI acquisition for a target object in a captured image according to the related art. FIG. 2 illustrates the skeleton information 5 of the person and the ROI 6 of the target object worked by the person, which are extracted from the captured image according to the related art.

An example on a left side in FIG. 2 is an example in which the ROI 6 of the target object is acquired by using an object recognition technique that is the related art. In this case, only the rough rectangle ROI 6 including the object that is the target object is acquired, and the acquired rectangle ROI6 is too wide. For example, when the ROI 6 is too wide, there is a possibility that erroneous detection in which the work of the person indicated by the skeleton information 5 on an object other than the target object is also determined as the work on the target object occurs.

An example on a right side in FIG. 2 is an example in which the ROI 6 of the target object is acquired by using CAD design data, for example. In this case, although it is possible to acquire the ROI 6 by narrowing down the target object to the component level, the acquired ROI 6 is too narrow. For example, when the ROI 6 is too narrow, there is a possibility that non-detection in which the work on the target object may not be detected due to variation in the work by the person indicated by the skeleton information 5 or estimation accuracy of the skeleton occurs.

As described above, in the related art, there may be a case where the ROI for the target object acquired from the captured image is too wide or too narrow, and the erroneous detection or the non-detection of the target object or the work on the target object occurs.

In one aspect, it is an object to provide a computer-readable recording medium storing an information processing program, an information processing method, and an information processing apparatus that may acquire a more appropriate ROI of a target object from a captured image.

Hereinafter, embodiments of an information processing program, an information processing method, and an information processing apparatus according to the present embodiment will be described in detail with reference to the drawings. The present embodiment is not limited by these embodiments. Each of the embodiments may be combined with an other embodiment as appropriate as long as they do not contradict each other.

### First Embodiment

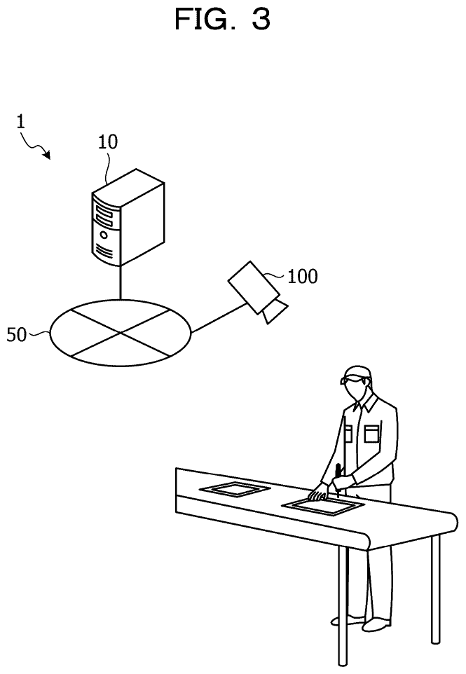

First, description is given of an information processing system for implementing the present embodiment. FIG. 3 is a diagram illustrating a configuration example of an information processing system according to a first embodiment. As illustrated in FIG. 3, an information processing system 1 is a system in which an information processing apparatus 10 and a camera device 100 are coupled to communicate with each other via a network 50.

As the network 50, for example, various communication networks such as an intranet used in a factory may be adopted regardless of wired or wireless. The network 50 may be, for example, an intranet and the Internet configured via a network device such as a gateway or another device (not illustrated), instead of a single network.

For example, the information processing apparatus 10 is an information processing apparatus such as a desktop personal computer (PC), a notebook PC, or a server computer that is installed in a factory and is used by a worker, an administrator, or the like.

For example, the information processing apparatus 10 receives, from the camera device 100, a plurality of images obtained by capturing a predetermined capturing range such as a predetermined work area in the factory with the camera device 100. Strictly, the plurality of images are a video, for example, a series of frames of a moving image captured by the camera device 100.

For example, the information processing apparatus 10 specifies, from a captured image, a target object such as a worker (hereinafter, may be simply referred to as a “person”) who works in the factory or a device on which the person works, by using an existing object detection technique. The information processing apparatus 10 generates, from the captured image, skeleton information of the person specified from the captured image by using an existing skeleton detection technique. For example, the information processing apparatus 10 specifies a first ROI in a three-dimensional space of the target object specified from the captured image based on design data that defines a region of an object present in the three-dimensional space such as CAD. Hereinafter, the ROI in the three-dimensional space may be referred to as a “3D ROI”, and the first ROI in the three-dimensional space may be referred to as a “first 3D ROI” or a “first region of interest”.

For example, the information processing apparatus 10 acquires a position distribution in which a part of a hand present in the three-dimensional space, based on a movement trajectory of the part of the hand in the generated skeleton information. For example, the information processing apparatus 10 sets a second ROI in the three-dimensional space indicating that the person uses the target object based on the acquired position distribution. Hereinafter, the second ROI in the three-dimensional space may be referred to as a “second 3D ROI” or a “second region of interest”.

Although the information processing apparatus 10 is illustrated as one computer in FIG. 3, the information processing apparatus 10 may be, for example, a distributed computing system including a plurality of computers. The information processing apparatus 10 may be a cloud computer apparatus managed by a service provider that provides a cloud computing service.

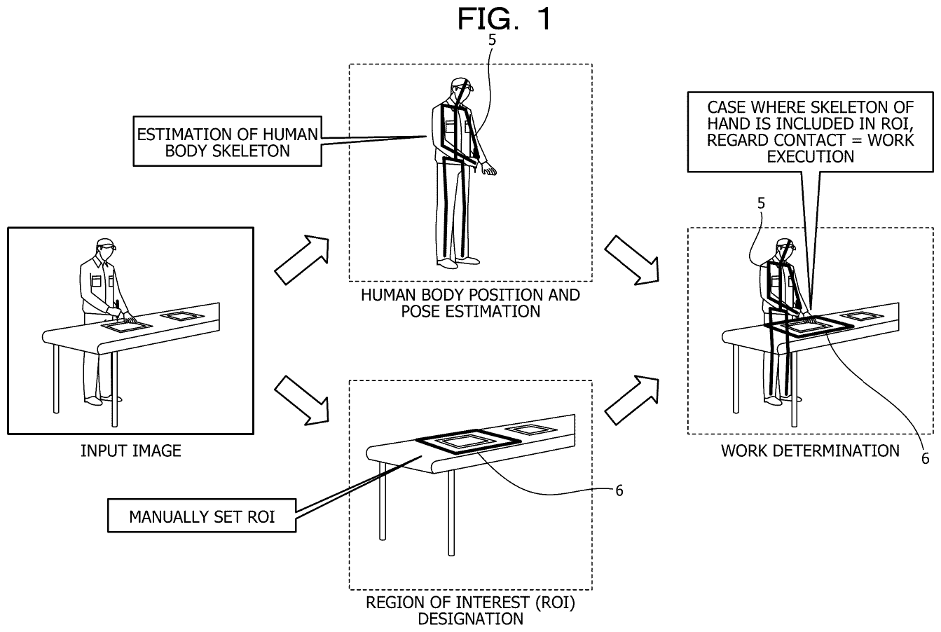

For example, the camera device 100 is a surveillance camera installed in the factory. Although one camera device 100 is illustrated in FIG. 1, a plurality of camera devices 100 may be installed in each work area in the factory in practice, for example. A video captured by the camera device 100 is transmitted to the information processing apparatus 10 at any time or at a predetermined timing.

### [Functional Configuration of Information Processing Apparatus 10]

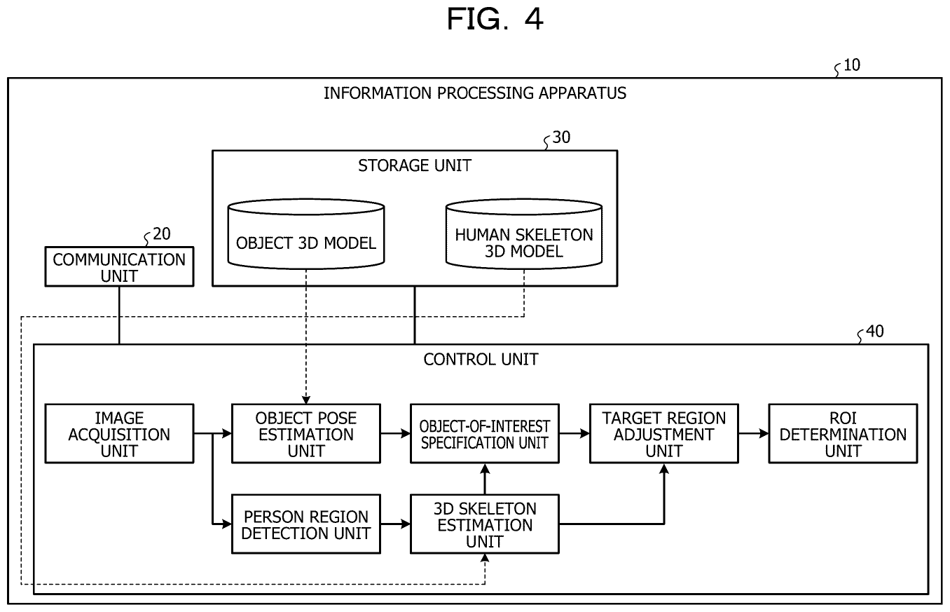

Next, a functional configuration of the information processing apparatus 10 serving as an execution entity according to the present embodiment will be described. FIG. 4 is a diagram illustrating a configuration example of the information processing apparatus 10 according to the first embodiment. As illustrated in FIG. 4, the information processing apparatus 10 includes a communication unit 20, a storage unit 30, and a control unit 40.

The communication unit 20 is a processing unit that controls communication with other devices such as the camera device 100, and is, for example, a communication interface such as a Universal Serial Bus (USB) interface or a network interface card.

The storage unit 30 has a function of storing various types of data and programs to be executed by the control unit 40, and is implemented by, for example, a storage device such as a memory or a hard disk. For example, the storage unit 30 stores an object 3D model for estimating a pose of an object that is a work target of a person, a human skeleton 3D model for estimating three-dimensional skeleton information of a person, and the like.

The storage unit 30 stores a plurality of captured images which are a series of frames captured by the camera device 100. The storage unit 30 may store positional information of the person or the object specified for the captured image in the image. The storage unit 30 stores two-dimensional skeleton information of the person specified from the captured image captured by the camera device 100.

The above-described information stored in the storage unit 30 is merely an example, and the storage unit 30 may store various types of information other than the above-described information.

The control unit 40 is a processing unit that controls the entire information processing apparatus 10, and is, for example, a processor or the like. The control unit 40 includes an image acquisition unit, an object pose estimation unit, an object-of-interest specification unit, a person region detection unit, a 3D skeleton estimation unit, a target region adjustment unit, an ROI determination unit, and the like. Each processing unit is an example of an electronic circuit of a processor, or an example of a process executed by the processor.

The image acquisition unit acquires, from the camera device 100, the plurality of captured images that are the series of frames captured by the camera device 100.

For example, the object pose estimation unit extracts an edge of the image captured by the camera device 100 by using an existing technique. For example, the object pose estimation unit estimates a position and a pose of each object that may be the work target of the person in the three-dimensional space by using a 3D line segment of the object 3D model and the corresponding edge in the captured image.

For example, the person region detection unit specifies, by using an existing object detection algorithm, a person from the image captured by the camera device 100, and detects a bounding box that is a region of the person. The existing object detection algorithm may be, for example, an object detection algorithm such as You Only Look Once (YOLO), a Single Shot Multibox Detector (SSD), and a Faster Convolutional Neural Network (R-CNN) using deep learning.

The 3D skeleton estimation unit estimates a pose of the person from a partial image in the bounding box of the person specified from the captured image and generate the two-dimensional skeleton information by using an existing technique such as a cascaded pyramid network (CPN). For example, the 3D skeleton estimation unit estimates three-dimensional skeleton coordinates of each part with respect to a reference position such as a hip of the two-dimensional skeleton information of the person by using an existing technique. Since the three-dimensional skeleton coordinates estimated by the 3D skeleton estimation unit are relative coordinates normalized from the reference position and dimensions between the parts are not actual dimensions, a scale of the person is estimated in the present embodiment. Since the three-dimensional skeleton coordinates estimated by the 3D skeleton estimation unit are the relative coordinates from the reference position, absolute coordinates with respect to world coordinates are calculated in the present embodiment.

For example, the 3D skeleton estimation unit converts relative three-dimensional skeleton coordinates of the person into absolute three-dimensional skeleton information with respect to the world coordinates by using a homography transformation matrix. For example, the homography transformation matrix may be calculated based on coordinates of predetermined four different points in the captured image obtained by capturing an inside of the factory and the world coordinates corresponding to each of the four points. As the absolute three-dimensional skeleton information, for example, absolute three-dimensional skeleton information of several parts such as a waist and a right leg may be calculated, and absolute coordinates of other parts may be calculated by using the calculated absolute coordinates of the waist and the right leg. Hereinafter, the calculated absolute three-dimensional skeleton information may be simply referred to as “3D skeleton information”.

For example, the object-of-interest specification unit specifies an object of interest among the objects whose position and pose have been estimated and specifies the first 3D ROI for the specified object by using the calculated 3D skeleton information.

For example, the target region adjustment unit corrects the specified first 3D ROI to adjust the ROI to a more appropriate ROI by using the calculated 3D skeleton information. For example, since the first 3D ROI specified by using the CAD design data may be too narrow compared to an actual work region, this processing is processing of correcting the first 3D ROI based on a position distribution of the hand part in the 3D skeleton information.

For example, the ROI determination unit performs processing of determining and setting the corrected first 3D ROI to the second 3D ROI indicating that the person uses the target object.

### [Details of Functions]

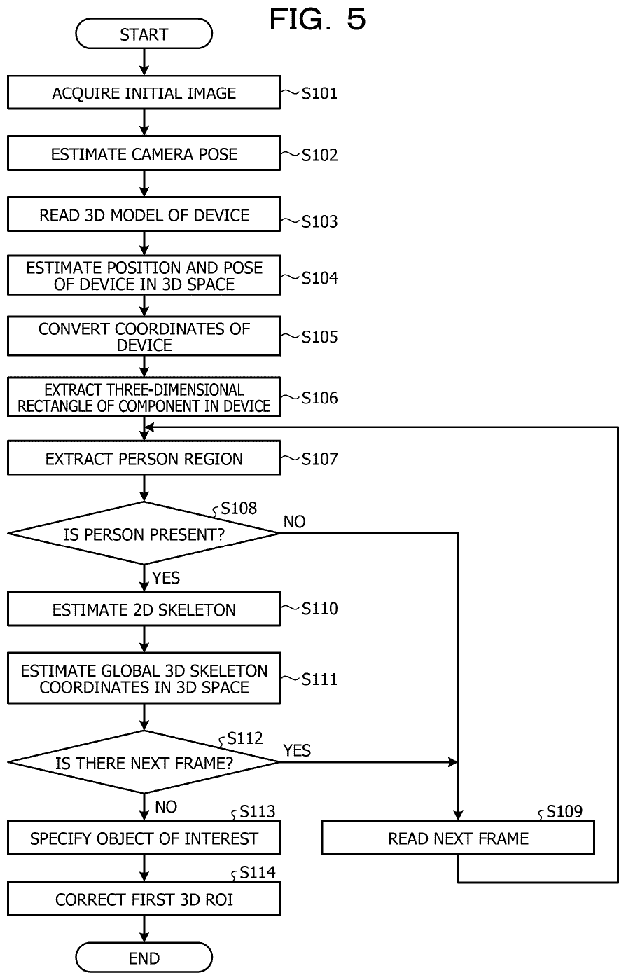

Next, 3D ROI setting processing executed by the information processing apparatus 10 as an operating entity will be described in detail below with reference to FIGS. 5 to 17. FIG. 5 is a flowchart illustrating a flow of the 3D ROI setting processing according to the first embodiment.

First, as illustrated in FIG. 5, for example, the information processing apparatus 10 acquires, from the storage unit 30, the captured image in which a predetermined capturing range such as a predetermined work region in a factory is captured by the camera device 100, and acquires an initial image (step S101). Strictly, the captured image acquired from the storage unit 30 is a video (hereinafter, may be referred to as “training data”) obtained by capturing a series of works in the predetermined work region.

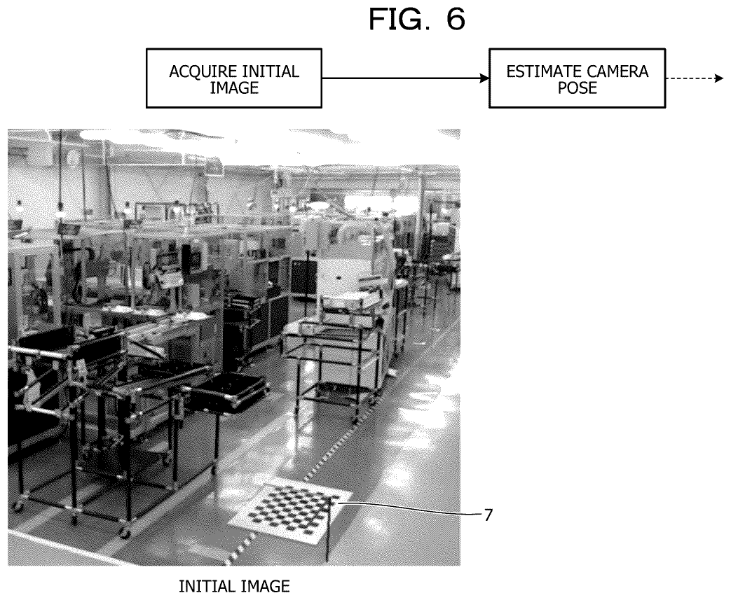

The initial image acquired in step S101 is, for example, an initial frame in which a device appears, which is acquired from the video that is the training data. FIG. 6 is a diagram illustrating an example of the initial image acquisition. An indicator 7 for obtaining a pose of the camera is captured in the initial image, and a specific position of the indicator 7 is set as an origin of the world coordinates.

Returning to the description of FIG. 5, next, the information processing apparatus 10 estimates the position and pose of the camera device 100 with respect to the world coordinates by using the indicator 7 according to the existing technique, for example (step S102). For example, the information processing apparatus 10 estimates the position and pose of the camera device 100 from a pair of three-dimensional coordinates of each corner of the indicator 7 and corresponding two-dimensional coordinates in the captured image. At this time, the position and pose of the camera device 100 is obtained in the form of a rotation matrix of 3×3 dimensions and a translation vector of three dimensions. For the estimation of the position and pose of the camera device 100, for example, a DLT method which is one of existing methods for estimating a homography matrix is used, and a homography matrix H_{lg} (3 rows×3 columns) is estimated from pairs of arbitrary 4 points on the indicator 7 and 4 respective points of three-dimensional coordinates in world coordinates corresponding to the arbitrary 4 points.

For example, next, the information processing apparatus 10 reads the 3D model of the device from the object 3D model stored in the storage unit 30 (step S103). The 3D model of the device to be read may be, for example, a 3D model of the device that may be the work target corresponding to the predetermined work region captured by the initial image acquired in step S101.

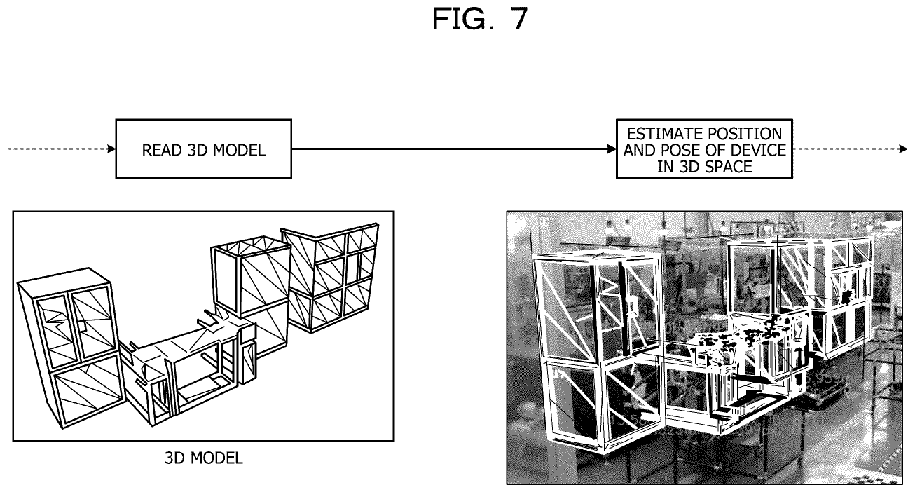

FIG. 7 is a diagram illustrating an example of the 3D position and pose estimation of the device. An image on a left side in FIG. 7 is an example of an image of the 3D model of the device, which is read in step S103. As illustrated on the left side in FIG. 7, a data format of the 3D model to be read may be, for example, an STL/OBJ format in which a three-dimensional shape is expressed by coupling triangular meshes, or the like. The information processing apparatus 10 determines coupling between the meshes from a degree of similarity between slopes of line segments constituting adjacent triangular meshes, and extracts, as 3D line segments, ridgelines of the 3D model of the device.

Returning to the description of FIG. 5, next, for example, the information processing apparatus 10 estimates the position and pose in the three-dimensional space of the device appearing in the initial image acquired in step S101 (step S104). For example, as illustrated on a right side of FIG. 7, the information processing apparatus 10 extracts, by using an existing technique, edges in the initial image acquired in step S101, and estimates the position and pose of the device by using these edges and 3D line segments of the 3D model extracted in step S103. The position and pose of the device are also obtained in the form of the rotation matrix of 3×3 dimensions and the translation vector of three dimensions, and the example on the right side of FIG. 7 is an example in which the 3D model is superimposed on the initial image by using the estimated rotation matrix and translation vector.

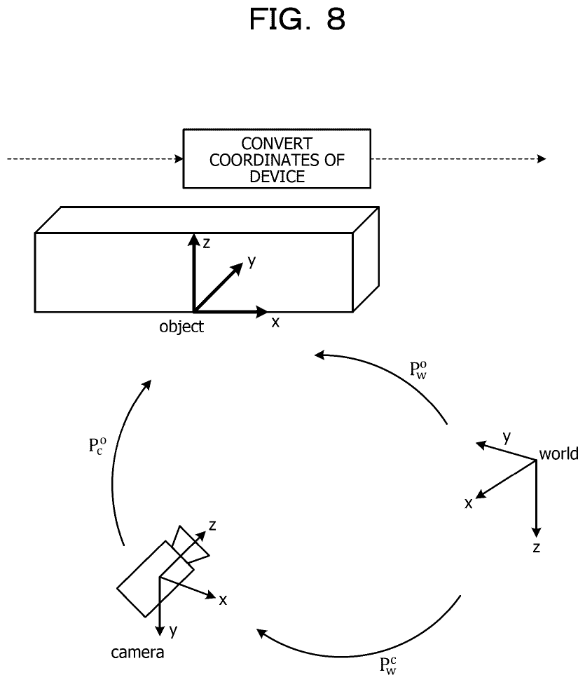

Returning to the description of FIG. 5, next, the information processing apparatus 10 converts, for example, relative coordinates of the device whose position and pose are estimated in step S104 into world coordinates (step S105). FIG. 8 is a diagram illustrating an example of conversion of the coordinates of the device. As illustrated in FIG. 8, the world coordinates of the device (object) may be calculated by Equation (1) below from a relationship between the relative coordinates and the world coordinates (world) of the camera device 100 (camera).

$$\begin{matrix}{x}_{w} = {P}_{w}^{o} {x}_{o} \\ = {P}_{w}^{c} {P}_{c}^{o} {x}_{o}\end{matrix} \qquad ( 1 )$$

In Equation (1), X_{W} is the world coordinates of the device whose position and pose are estimated in step S104. X₀ is the relative coordinates of the device whose position and pose are estimated, and may be, for example, four-dimensional coordinates obtained by adding 1 to a fourth dimension, for example, homogeneous coordinates. P_{W}^{O} is a matrix for converting relative coordinates of the device into coordinates in a world coordinate system, and P_{W}^{c} is a matrix for converting relative coordinates of the camera device 100 into coordinates in the world coordinate system. P_{c}^{O} is a matrix for converting relative coordinates of the device into coordinates in a relative coordinate system of the camera device. A matrix P is expressed by Equation (2) below, for example.

$$P = ( \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z} \\ 0 & 0 & 0 & 1\end{matrix} ) \qquad ( 2 )$$

In Equation (2), a portion of r₁₁ to r₃₃ is a rotation matrix, and a portion of tₓ to t_{z} is a translation vector.

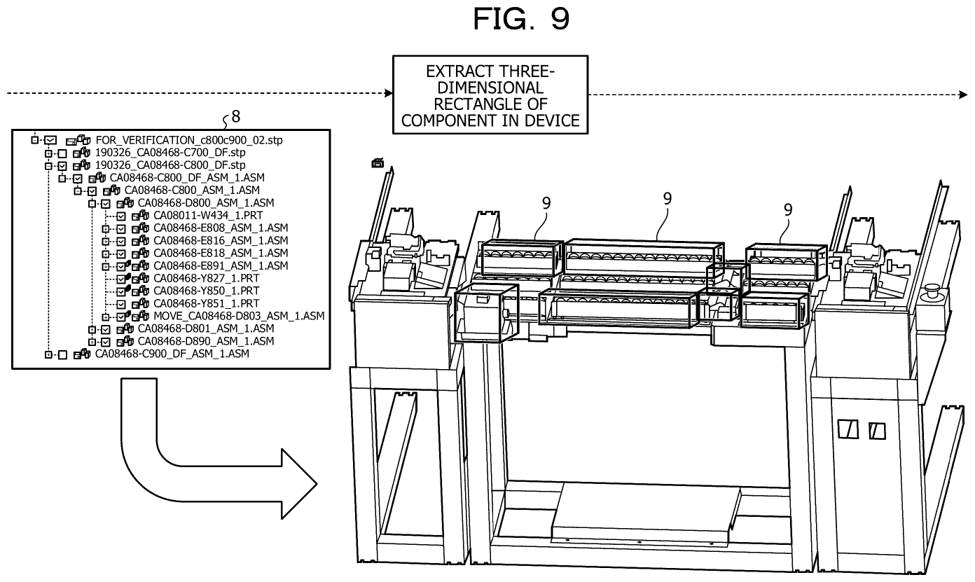

Returning to the description of FIG. 5, next, the information processing apparatus 10 extracts, for example, a three-dimensional rectangle of a component in the device whose position and pose are estimated in step S104 (step S106). FIG. 9 is a diagram illustrating an example of extraction of a three-dimensional rectangle of a component in the device. As illustrated in FIG. 9, for example, CAD design data 8 is stored in a hierarchical structure in which, for each device, pieces of information of components in the device are nested. Thus, for example, the information processing apparatus 10 may extract a three-dimensional rectangle 9 of each component in the device by acquiring end points, for example, relative coordinates, of the component in a specific hierarchy level such as a fourth hierarchy level. Since the world coordinates of the device are obtained in step S105, the information processing apparatus 10 calculates, for example, the world coordinates of the end points of the three-dimensional rectangle 9 of each component based on the world coordinates of the device.

Returning to the description of FIG. 5, next, the information processing apparatus 10 extracts a rectangular region surrounding the person, for example, a bounding box, from the captured image by using an existing object detection algorithm, for example (step S107). Since processing of step S107 and subsequent steps is repeatedly performed for each frame of the video that is the training data, which is obtained by capturing the series of works, the captured image at a first time is the initial image acquired in step S101.

For example, in a case where no person region is extracted from the captured image in step S107 and it is determined that no person is present in the captured image (step S108: No), the information processing apparatus 10 reads a next frame of the video that is the training data (step S109). The processing is repeated for the next frame from step S107.

On the other hand, in a case where a person region is extracted from the captured image and it is determined that a person is present in the captured image (step S108: Yes), the information processing apparatus 10 estimates two-dimensional skeleton information of the person by using, for example, an existing skeleton estimation algorithm (step S110). The existing skeleton estimation algorithm is, for example, a skeleton estimation algorithm using deep learning such as HumanPoseEstimation of DeepPose, OpenPose, or the like.

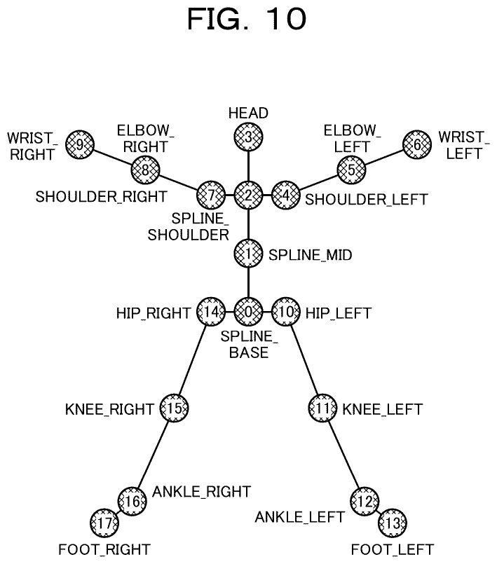

Regarding estimation of the two-dimensional skeleton information, for example, the information processing apparatus 10 may acquire the two-dimensional skeleton information by inputting image data (each frame) to a trained machine learning model. FIG. 10 is a diagram illustrating an example of skeleton information. Eighteen pieces (No. 0 to No. 17) of definition information in which joints specified by a known skeleton model are numbered may be used as the two-dimensional skeleton information. For example, No. 7 is assigned to a right shoulder joint (SHOULDER_RIGHT), No. 5 is assigned to a left elbow joint (ELBOW_LEFT), No. 11 is assigned to a left knee joint (KNEE_LEFT), and No. 14 is assigned to a right hip joint (HIP_RIGHT). Accordingly, the information processing apparatus 10 may acquire 18 pieces of skeleton coordinate information illustrated in FIG. 10 from the image data. For example, the information processing apparatus 10 acquires “X coordinate=X7, Y coordinate=Y7, Z coordinate=Z7” as a position of the right shoulder joint of No. 7. For example, a Z-axis may be defined as a distance direction from the capturing device toward the target, a Y-axis may be defined as a height direction perpendicular to the Z-axis, and an X-axis may be defined as a horizontal direction.

The information processing apparatus 10 may determine a pose of a whole body such as standing, walking, crouching, sitting, or lying by using a machine learning model trained on skeleton patterns in advance. For example, the information processing apparatus 10 may determine a closest pose of the whole body by using a machine learning model trained, with a multilayer perceptron, on some of joints and angles between the joints as in skeleton information of FIG. 10 or a diagram of excellent skills.

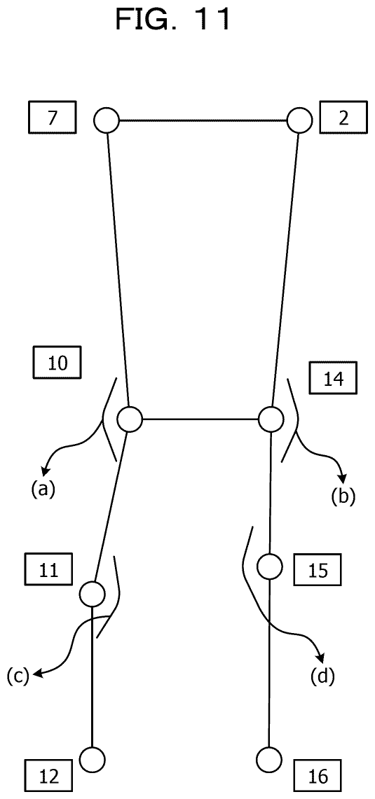

FIG. 11 is a diagram illustrating an example of pose determination of the whole body. As illustrated in FIG. 11, the information processing apparatus 10 may detect the pose of the whole body by acquiring an angle (a) of a joint between “HIP_LEFT” of No. 10 and “KNEE_LEFT” of No. 11, an angle (b) of a joint between “HIP_RIGHT” of No. 14 and “KNEE_RIGHT” of No. 15, an angle (c) of “KNEE_LEFT” of No. 11, an angle (d) of “KNEE_RIGHT” of No. 15, and the like.

The information processing apparatus 10 may estimate the pose by using a machine learning model such as multilayer perceptron generated by machine learning with some joints and the angles between the joints as feature quantities and the pose of the whole body such as standing or crouching as a ground truth label.

As the pose estimation algorithm, the information processing apparatus 10 may use a 3D pose estimation such as VNect that estimates a three-dimensional pose from one captured image. For example, the information processing apparatus 10 may estimate a pose from three-dimensional joint data by using a 3d-pose-baseline that generates the three-dimensional joint data from two-dimensional skeleton information.

The information processing apparatus 10 may specify a motion for each part based on an orientation, an angle in a case of bending, or the like for each part such as a face, an arm, and an elbow of the person, and may estimate the pose of the person. The algorithm for the pose estimation and the skeleton estimation is not limited to one type, and the pose and the skeleton may be estimated in a complex manner by using a plurality of algorithms.

Returning to the description of FIG. 5, next, the information processing apparatus 10 estimates global three-dimensional skeleton coordinates of each part in the three-dimensional space with respect to the reference position such as the hip of the two-dimensional skeleton information of the person by using an existing technique, for example (step S111). For example, first, the information processing apparatus 10 estimates relative three-dimensional skeleton coordinates of each part with respect to the reference position such as the hip of the two-dimensional skeleton information of the person, for example.

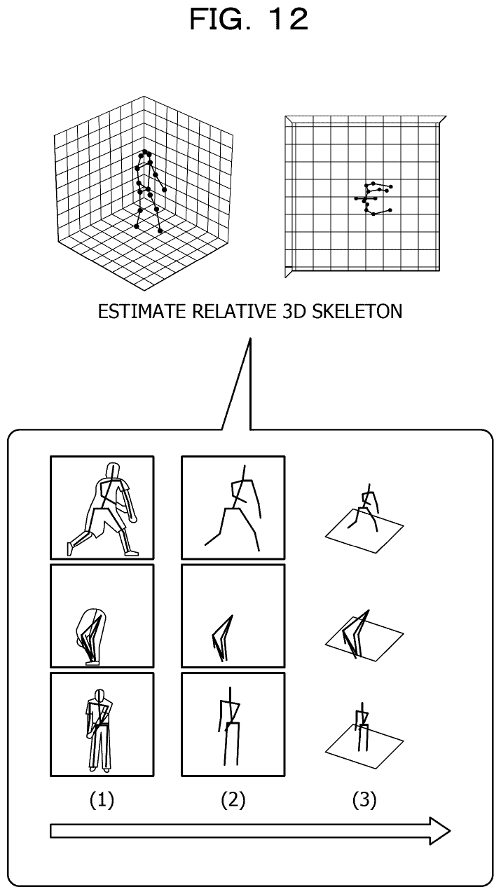

FIG. 12 is a diagram illustrating an example of the relative 3D skeleton coordinate estimation. As illustrated in FIG. 12, the estimation of the relative three-dimensional skeleton coordinates is performed (1) for an input image in which the person appears, by (2) obtaining for example, a true value of each part with the position of the hip as the reference, and (3) estimating the relative three-dimensional coordinates of each part from the hip.

For example, the information processing apparatus 10 converts the estimated relative three-dimensional skeleton coordinates into the absolute three-dimensional skeleton information with respect to the world coordinates by using the homography transformation matrix. For example, the homography transformation matrix is calculated by the information processing apparatus 10 by using an existing technique such as a direct linear transformation (DLT) method. The homography transformation matrix is represented by Equation (3) below.

$$( \begin{matrix}x \\ y \\ 1\end{matrix} ) = ( \begin{matrix}{h}_{11} & {h}_{12} & {h}_{13} \\ {h}_{21} & {h}_{22} & {h}_{23} \\ {h}_{31} & {h}_{32} & 1\end{matrix} ) ( \begin{matrix}u \\ v \\ 1\end{matrix} ) \qquad ( 3 )$$

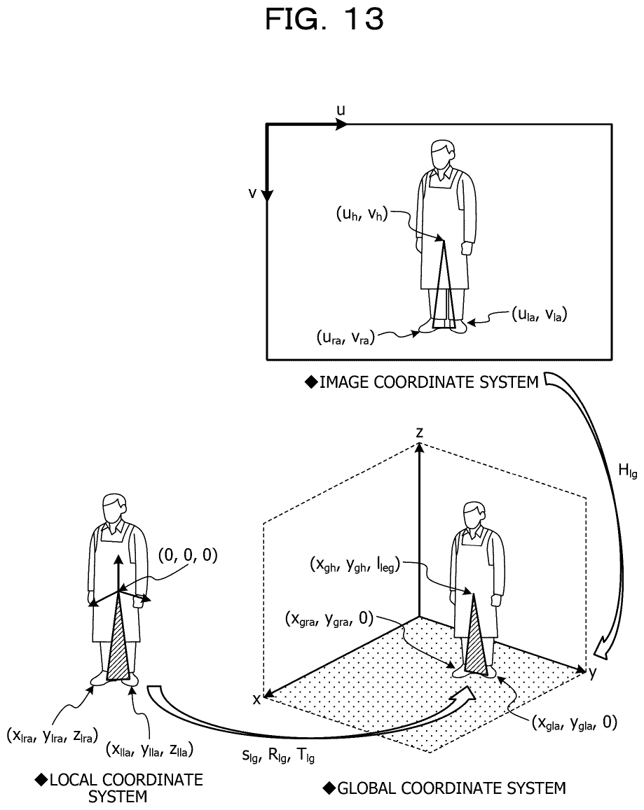

In Equation (3), u and v indicate input two-dimensional coordinates, and x, y, and 1 (z value) indicate converted three-dimensional coordinates. For example, the information processing apparatus 10 estimates three-dimensional coordinates x and y of a foot from the homography transformation matrix. FIG. 13 is a diagram illustrating an example of a positional relationship between coordinate systems in 2D and 3D. FIG. 13 illustrates the positional relationship between the coordinate systems. As illustrated in FIG. 13, for example, for each of the right leg and the left leg, two-dimensional coordinates (uᵣₐ, vᵣₐ) and (uₗₐ, vₗₐ) are converted into the three-dimensional coordinates by using the homography transformation matrix, and thus the three-dimensional coordinates x and y of the foot are calculated. The calculation of the three-dimensional coordinates of the right leg and the left leg is represented by, for example, Equations (4) and (5) below.

$$( \begin{matrix}{x}_{gra} \\ {y}_{gra} \\ 1\end{matrix} ) = {H}_{lg} ( \begin{matrix}{u}_{ra} \\ {v}_{ra} \\ 1\end{matrix} ) \qquad ( 4 )$$

$$( \begin{matrix}{x}_{gla} \\ {y}_{gla} \\ 1\end{matrix} ) = {H}_{lg} ( \begin{matrix}{u}_{la} \\ {v}_{la} \\ 1\end{matrix} ) \qquad ( 5 )$$

In Equations (4) and (5), H_{lg} is the homography transformation matrix represented by Equation (3). For example, as illustrated in FIG. 13, the x and y coordinates of the hip may be defined as middle points of both legs. The z coordinate of the hip may be set to, for example, a fixed value as a I_{leg}.

For example, the information processing apparatus 10 estimates similarity conversion parameters s_{lg}, R_{lg}, and T_{lg} from local three-dimensional skeleton coordinates to global three-dimensional skeleton coordinates by using an existing technique such as procrustes analysis such that the converted coordinates are closest. The information processing apparatus 10 converts the local three-dimensional skeleton coordinates into the global three-dimensional skeleton coordinates by using the estimated similarity conversion parameters s_{lg}, R_{lg}, and T_{lg}, respectively. The conversion into the global three-dimensional skeleton coordinates is represented by, for example, Equation (6) below.

$$( \begin{matrix}{x}_{g} \\ {y}_{g} \\ {z}_{g}\end{matrix} ) = {s}_{lg} {R}_{lg} ( \begin{matrix}{x}_{l} \\ {y}_{l} \\ {z}_{l}\end{matrix} ) + {T}_{lg} \qquad ( 6 )$$

Returning to the description of FIG. 5, next, in a case where there is a next frame of the video that is the training data (step S112: Yes), the information processing apparatus 10 reads the next frame (step S109), for example, and the processing is repeated for the next frame from step S107. For example, the estimated global three-dimensional skeleton coordinates may be stored in the storage unit 30 or the like for each frame.

In a case where there is no next frame (step S112: No), the information processing apparatus 10 specifies an object of interest from among the components for which the three-dimensional rectangle is extracted in step S106 (step S113), for example. The specification of the object of interest may be performed based on a work process table or the like indicating which work is to be performed on which component for each work time zone. The object of interest specified herein is the first object 3D ROI.

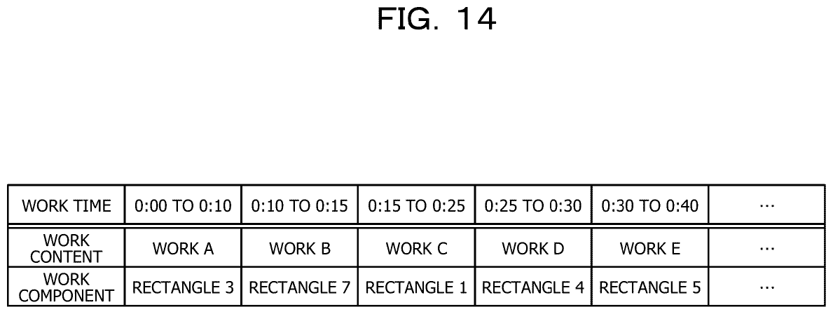

FIG. 14 is a diagram illustrating an example of the work process table. The work process table illustrated in FIG. 14 is data in which work contents to be performed for each work time zone and work components corresponding to the work contents are stored in association with each other. Regarding generation of the work process table illustrated in FIG. 14, for example, distances between positions of both hands and a center of the three-dimensional rectangle of each component among the global 3D skeleton coordinates are calculated for each work time zone, the three-dimensional rectangle with a closest sum of the distances is registered as a work component, and the work process table is generated. For example, the work component registered as the three-dimensional rectangle for each work time zone may be specified as the object of interest in the work time zone. The work time zone in step S113 may be determined by an elapsed time or the like associated with each frame of the video that is the training data.

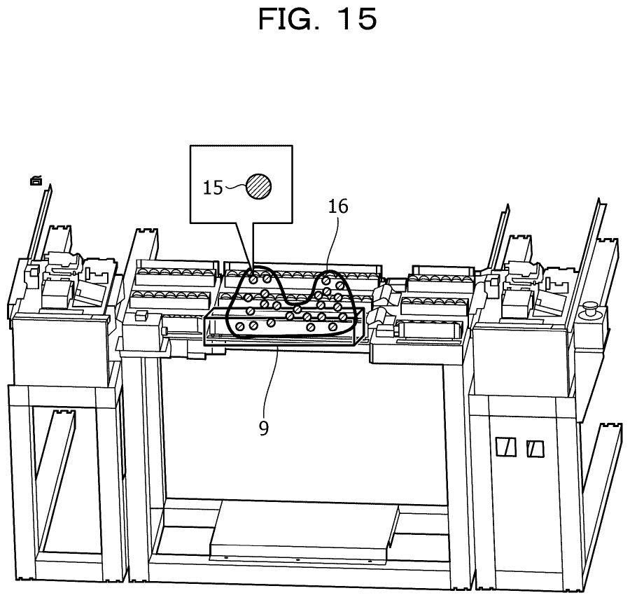

Returning to the description of FIG. 5, next, the information processing apparatus 10 corrects the first 3D ROI, which is the object of interest, with the second 3D ROI, for example (step S114). FIG. 15 is a diagram illustrating an example of 3D ROI setting. In FIG. 15, the three-dimensional rectangle 9 is the object of interest and is the first 3D ROI. For example, as illustrated in FIG. 15, the information processing apparatus 10 plots spheres 15 having a radius r such as a 5 cm (centimeters), for example, in the three-dimensional space with respect to the positions of both hands of the global 3D skeleton coordinates for each work time. For each work time, the information processing apparatus 10 calculates a sum set 16 in the three-dimensional space including the spheres 15, and sets the sum set 16 as the second 3D ROI indicating that the person uses the object of interest represented by the three-dimensional rectangle 9.

For example, in a case where the information processing apparatus 10 determines whether or not the object of interest is used, the information processing apparatus 10 determines whether or not the positions of both hands of the global 3D skeleton coordinates are included in the sum set 16 set as the second 3D ROI instead of whether or not the positions of both hands of the global patient skeleton coordinates are included in the three-dimensional rectangle 9. Accordingly, the three-dimensional rectangle 9 set as the first 3D ROI is corrected by the sum set 16 set as the second 3D ROI, and a more appropriate ROI of the target object which is the object of interest may be acquired from the captured image.

After the execution of step S114, the 3D ROI setting processing illustrated in FIG. 5 ends. However, at this time, the second 3D ROI set as a more appropriate ROI may be stored in the storage unit 30 or the like in an STL format or the like, for example, by being regarded as a convex polyhedron which is represented by coupling of planar triangles and in which each vertex indicates a surface shape.

### Second Embodiment

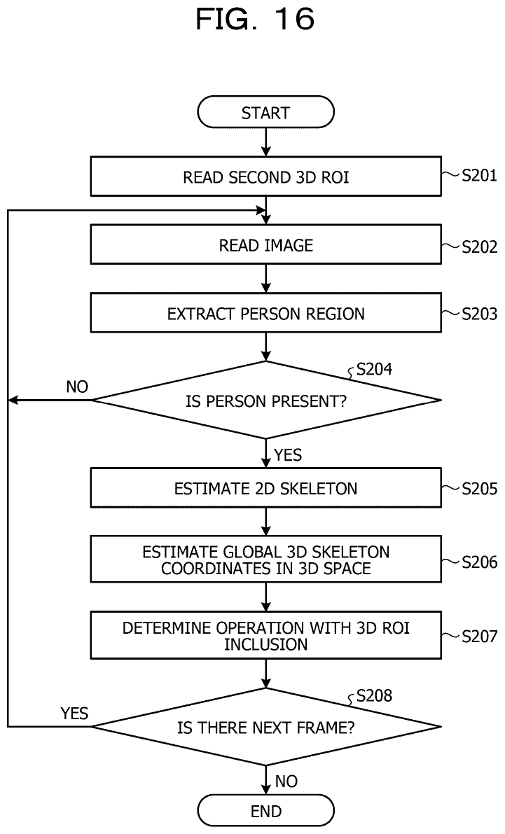

Next, a second embodiment in which a motion of a person is determined by using the second 3D ROI set in the first embodiment will be described. Configurations of an information processing system according to the second embodiment and an information processing apparatus 10 as an operating entity are similar to the configurations illustrated in FIGS. 3 and 4, respectively, in the first embodiment. FIG. 16 is a flowchart illustrating a flow of motion determination processing using the 3D ROI according to the second embodiment.

First, as illustrated in FIG. 16, the information processing apparatus 10 reads the second 3D ROI set in the first embodiment, for example (step S201). For example, the second 3D ROI is a second 3D ROI set by correcting the first 3D ROI which is the object of interest in step S114 of the 3D ROI setting processing according to the first embodiment illustrated in FIG. 5.

For example, the information processing apparatus 10 acquires, from the storage unit 30, a captured image in which a predetermined capturing range such as a predetermined work region in a factory is captured by the camera device 100, and reads the captured image (step S202). According to the second embodiment, to process the captured image captured by the camera device 100, strictly, a surveillance video in real time, the captured image is transmitted from the camera device 100 at any time and is stored in the storage unit 30.

Next, the information processing apparatus 10 extracts the rectangular region surrounding the person, for example, the bounding box, from the captured image read in step S202 by using an existing object detection algorithm, for example (step S203).

In a case where no person region is extracted from the captured image in step S203 and it is determined that no person is present in the captured image (step S204: No), the processing returns to step S202, and the information processing apparatus 10 reads, for example, a next frame of the surveillance video (step S202). The processing is repeated for the next frame from step S203.

In a case where a person region is extracted from the captured image and it is determined that a person is present in the captured image (step S204: Yes), the information processing apparatus 10 estimates two-dimensional skeleton information of the person by using, for example, an existing skeleton estimation algorithm (step S205). The estimation processing of the two-dimensional skeleton information in step S205 is similar to the estimation processing of the two-dimensional skeleton information in step S110 in the 3D ROI setting processing according to the first embodiment illustrated in FIG. 5.

Next, by using an existing technique, for example, the information processing apparatus 10 estimates the global three-dimensional skeleton coordinates of each part in the three-dimensional space with respect to the reference position such as the hip of the two-dimensional skeleton information of the person estimated in step S205 (step S206). The estimation processing of the three-dimensional skeleton coordinates in step S206 is similar to the estimation processing of the three-dimensional skeleton coordinates in step S111 in the 3D ROI setting processing according to the first embodiment illustrated in FIG. 5.

Next, for example, the information processing apparatus 10 determines the motion of the person depending on whether or not the positions of both hands of the global 3D skeleton coordinates of the person in the captured image are included in the second ROI read in step S201 (step S207). For example, in a case where the positions of both hands of the global 3D skeleton coordinates are included in the second ROI, the information processing apparatus 10 may determine that the person in the captured image is using the target object such as performing the work on the target object such as the component corresponding to the second ROI. The motion determination in step S207 will be described in more detail.

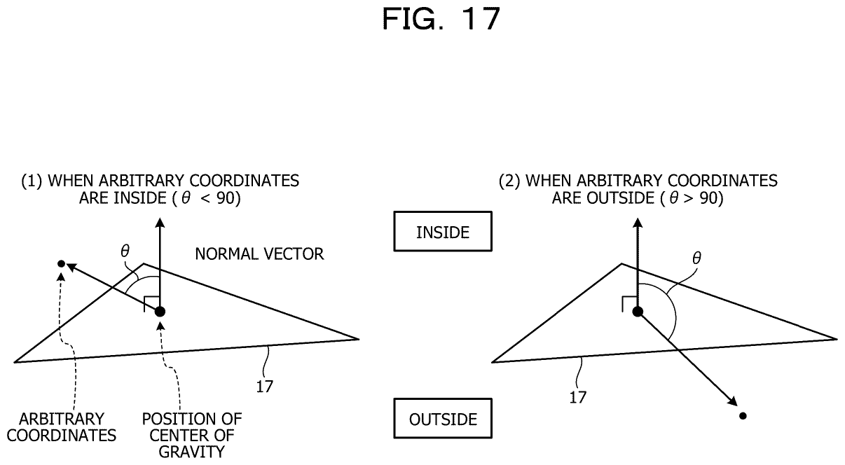

FIG. 17 is a diagram illustrating an example of the motion determination using the 3D ROI. FIG. 17 illustrates measurement of a positional relationship between 3D coordinate points to be determined, such as coordinates of the right hand of the person in the captured image, for each of triangular meshes 17 of the read second ROI.

For example, the information processing apparatus 10 calculates a normal vector for each of the meshes 17, and calculates an angle formed by the normal vector and a vector of the right hand coordinates from a position of a center of gravity. For example, in a case where angles formed with respect to all the meshes 17 of the read second ROI are equal to or smaller than 90 degrees, the information processing apparatus 10 may determine that the right hand of the person in the captured image is included in the second ROI.

Returning to the description of FIG. 16, next, in a case where there is a next frame of the surveillance video (step S208: Yes), the information processing apparatus 10 reads the next frame (step S202), for example, and the processing is repeated for the next frame from step S203.

In a case where there is no next frame (step S208: No), the motion determination processing illustrated in FIG. 16 ends.

### [Effects]

As described above, the information processing apparatus 10 generates three-dimensional first skeleton information of a first person included in a first video by performing skeleton recognition on the first person, sets a first region of interest in a three-dimensional space for each of a plurality of objects included in the first video, based on design data that is stored in advance and defines regions of the objects present in the three-dimensional space, specifies a first object being used by the first person from among the plurality of objects included in the first video by using positional information of a part of a hand of the first skeleton information and the first region of interest, acquires a position distribution in which the part of the hand is present in the three-dimensional space based on a trajectory of movement of the part of the hand of the first skeleton information, and sets a second region of interest, in the three-dimensional space, that indicates that a person uses the first object, based on the position distribution in which the part of the hand is present.

As described above, the information processing apparatus 10 sets the 3D object ROI of the target object from the video based on the design data that defines the region of the object present in the three-dimensional space, acquires the position distribution of the part of the hand based on the trajectory of the hand of the 3D skeleton information of the person included in the video, and corrects the 3D object ROI. Accordingly, the information processing apparatus 10 may acquire a more appropriate ROI of the target object from the captured image.

The processing of setting the second region of interest executed by the information processing apparatus 10 includes setting a region of a predetermined range with a position of the hand as a center in the three-dimensional space based on the position distribution in which the part of the hand is present, and setting, as the second region of interest, a region, in the three-dimensional space, that includes the region of the predetermined range.

Accordingly, the information processing apparatus 10 may acquire a more appropriate ROI.

The processing of setting the first region of interest executed by the information processing apparatus 10 includes setting, as the first region of interest, a region in the three-dimensional space for each of the plurality of objects based on end points of the object included in the design data.

Accordingly, the information processing apparatus 10 may acquire a more appropriate ROI.

The information processing apparatus 10 generates three-dimensional second skeleton information of a second person included in a second video by performing skeleton recognition on the second person, and determines whether or not the second person uses the first object, based on positional information of a part of a hand of the second skeleton information and the second region of interest.

Accordingly, the information processing apparatus 10 may more accurately determine the motion of the person with respect to the target object.

### [System]

Unless otherwise specified, the processing procedures, control procedures, specific names, and information including various types of data and parameters described in the above description or drawings may be arbitrarily changed. The specific examples, distribution, numerical values, and the like described in the exemplary embodiment are merely examples, and may be arbitrarily changed.

The specific form of distribution or integration of the elements in devices or apparatuses is not limited to the specific form illustrated in the drawings. For example, all or a part of the constituent elements may be functionally or physically distributed or integrated in arbitrary units depending on various types of loads, usage states, or the like. All or an arbitrary subset of the processing functions performed by the apparatus may be realized by a central processing unit (CPU) and a program analyzed and executed by the CPU or may be realized by hardware using wired logic.

### [Hardware]

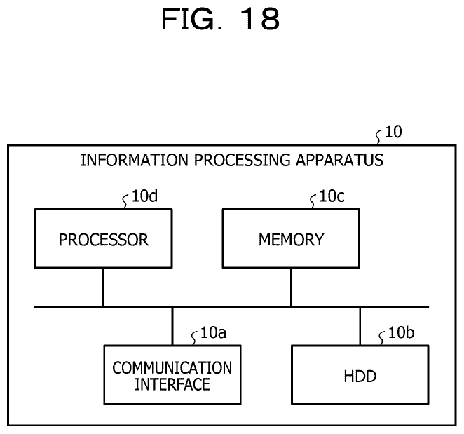

FIG. 18 is a diagram for describing a hardware configuration example of the information processing apparatus 10. As illustrated in FIG. 18, the information processing apparatus 10 includes a communication interface 10a, a hard disk drive (HDD) 10b, a memory 10c, and a processor 10d. The units illustrated in FIG. 18 are coupled to each other by a bus or the like.

The communication interface 10a is a network interface card or the like, and performs communication with other information processing apparatuses. The HDD 10b stores programs and data for causing the functions illustrated in FIG. 4 to operate.

The processor 10d is a hardware circuit that reads, from the HDD 10b or the like, a program for executing processing similar to that of the respective processing units illustrated in FIG. 4 and loads the program to the memory 10c to operate a process of executing each of the functions illustrated in FIG. 4 and so forth. For example, this process executes a function similar to that of the respective processing units included in the information processing apparatus 10. For example, the processor 10d reads a program having functions similar to the functions of the image acquisition unit, the object pose estimation unit, and the like from the HDD 10b or the like. The processor 10d executes a process of executing the processing similar to the processing of the image acquisition unit, the object pose estimation unit, and the like.

As described above, the information processing apparatus 10 operates as an information processing apparatus that executes an operation control process by reading and executing the program that executes the processes similar to those of the respective processing units illustrated in FIG. 4. The information processing apparatus 10 may also achieve functions similar to the functions in the embodiments described above by reading the program from a recording medium with a medium reading device and executing the read program. The program described in another embodiment is not limited to the program to be executed by the information processing apparatus 10. For example, the present embodiment may be similarly applied to a case where another computer or server executes the program and a case where the computer and the server cooperate with each other to execute the program.

The program for executing the processing similar to that of the respective processing units illustrated in FIG. 4 may be distributed through a network such as the Internet. This program may be recorded on a computer-readable recording medium such as a hard disk, a flexible disk (FD), a compact disc read-only memory (CD-ROM), a magneto-optical (MO) disk, or a Digital Versatile Disc (DVD) and may be executed by being read from the recording medium by a computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
generating three-dimensional first skeleton information of a first person included in a first video by performing skeleton recognition on the first person;
setting a first region of interest in a three-dimensional space for each of a plurality of objects included in the first video, based on design data that is stored in advance and defines regions of the objects present in the three-dimensional space;
specifying a first object being used by the first person from among the plurality of objects included in the first video by using positional information of a part of a hand of the first skeleton information and the first region of interest;
acquiring a position distribution in which the part of the hand is present in the three-dimensional space based on a trajectory of movement of the part of the hand of the first skeleton information; and
setting a second region of interest, in the three-dimensional space, that indicates that a person uses the first object, based on the position distribution in which the part of the hand is present.

2. The non-transitory computer-readable recording medium according to claim 1, wherein
the setting of the second region of interest includes
setting a region of a predetermined range with a position of the hand as a center in the three-dimensional space based on the position distribution in which the part of the hand is present, and
setting, as a second region of interest, a region, in the three-dimensional space, that includes the region of the predetermined range.

3. The non-transitory computer-readable recording medium according to claim 1, wherein
the setting of the first region of interest includes
setting, as the first region of interest, a region in the three-dimensional space for each of the plurality of objects based on end points of the object included in the design data.

4. The non-transitory computer-readable recording medium according to claim 1, the process further comprising:
generating three-dimensional second skeleton information of a second person included in a second video by performing skeleton recognition on the second person; and
determining whether or not the second person uses the first object, based on positional information of a part of a hand of the second skeleton information and the second region of interest.

5. An information processing method implemented by a computer, the information processing method comprising:
generating three-dimensional first skeleton information of a first person included in a first video by performing skeleton recognition on the first person;
setting a first region of interest in a three-dimensional space for each of a plurality of objects included in the first video, based on design data that is stored in advance and defines regions of the objects present in the three-dimensional space;
specifying a first object being used by the first person from among the plurality of objects included in the first video by using positional information of a part of a hand of the first skeleton information and the first region of interest;
acquiring a position distribution in which the part of the hand is present in the three-dimensional space based on a trajectory of movement of the part of the hand of the first skeleton information; and
setting a second region of interest, in the three-dimensional space, that indicates that a person uses the first object, based on the position distribution in
which the part of the hand is present.

6. An information processing apparatus comprising:
a memory; and
a processor coupled with the memory and configured to:
generate three-dimensional first skeleton information of a first person included in a first video by performing skeleton recognition on the first person;
set a first region of interest in a three-dimensional space for each of a plurality of objects included in the first video, based on design data that is stored in advance and defines regions of the objects present in the three-dimensional space;
specify a first object being used by the first person from among the plurality of objects included in the first video by using positional information of a part of a hand of the first skeleton information and the first region of interest;
acquire a position distribution in which the part of the hand is present in the three-dimensional space based on a trajectory of movement of the part of the hand of the first skeleton information; and
set a second region of interest, in the three-dimensional space, that indicates that a person uses the first object, based on the position distribution in which the part of the hand is present.
